(19) United States
(12) Patent Application Publication
(10) Pub. No.: US 2007/0078716 A1
(43) Pub. Date: Apr. 5, 2007

(54) System and method of on-line merchandising

(76) Inventor: Serge Tews, Bal Harbour, FL (US)

Correspondence Address: MALLOY & MALLOY, P.A., 2800 S.W. Third Avenue, Historic Coral Way, Miami, FL, 33129, US

(21) Appl. No.: 11/527,007

(22) Filed: Sep. 26, 2006

Related U.S. Application Data
(63) Continuation-in-part of application No. 10/810,155, filed on Mar. 26, 2004.

(51) Int. Cl. G06Q 30/00

(52) U.S. Cl. 705/14

(57) ABSTRACT

A system and method for on-line merchandising utilizing a gaming or promotional format which includes the on-line purchase of a pre-determined number of bids or entries each representing an equal opportunity for being awarded preselected merchandise at a reduced cost. A customer having purchased one or more bids from a bid pool will be awarded the merchandise at a reduced price by holding a randomly selected winning bid. An included distribution format comprises the additional awarding of preselected merchandise, or a substantial equivalent thereof, to any customer having purchased a quantity of bids with a collective monetary value which is at least substantially equal to the purchase price of the preselected merchandise.

### CLAIM OF PRIORITY

The present application is a continuation-in-part application of previously filed, now pending application having Ser. No. 10/810,155, filed on Mar. 26, 2004 incorporated herein in its entirety by reference.

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND OF THE INVENTION

1. Field of the Invention

This invention relates to a system and method for distributing preselected merchandise to entry purchasing customers by means of a drawing, lottery, raffle or other distribution format, at a potentially reduced price but at no more than a cost to the customer which is substantially equal to the full purchase price of the preselected merchandise.

2. Description of the Related Art

It is widely accepted that the most rapidly growing commercial segment of today's economy is merchandising products and services over public communication networks and specifically the Internet. Using the Internet, the annual increase in electronic commercial transactions has amounted to millions of dollars for each of the past few years. The advantage of computer-based merchandising systems using the Internet is obvious when compared to more conventional types and areas of merchandising.

By way of example, prior to the development and popularity presently enjoyed by computer-based merchandising systems, customers were typically required to visit specific physical locations such as retail, wholesale and like distribution outlets. The disadvantages and problems associated with such conventional techniques involved access to a limited number of customers which could physically visit an outlet. Such restrictive exposure is based either on the geographical location of the outlet and/or the size and/or distribution facilities associated therewith. In addition, conventional distribution outlets, because of limited physical facilities, normally carry a specialized and/or relatively small selection of products. Such limitations sometimes results in the customers having to visit a plurality of such outlets in order to be exposed to a full range of products, services, etc. Some of the noted exceptions to the limited merchandise availability of such outlets is the conventional “supermarket” grocery store and other expansive facilities maintained by extremely large retailers commonly known to the consuming pubic. However, even such exceptions have limitations which could only be overcome by the establishment of a plurality of outlets or a “chain” of such outlets located throughout one or more geographical areas.

In contrast to the known techniques and physical limitations of conventional distribution outlets, as set forth above, Internet based merchandising systems can reach literally millions of people and offer an almost inexhaustible variety of products, services and other valuable merchandise. Moreover, advantages to the customer while shopping on-line include access to thousands of electronic vendors from the convenience of a customer's home or other area where Internet access facilities are located. However, perhaps one disadvantage associated with on-line merchandising, at least from the point of view of a vendor, is the rapidly escalating competitive nature of computer-based merchandising systems as evidenced by the extremely large number of on-line vendors. As a result, many on-line vendors have resorted to auctions, lotteries, raffles or like electronic gaming formats which appear to present the customer with an opportunity to obtain the desired merchandise at a reduced cost.

Also, such gaming formats, procedures, systems, etc., may add to the excitement experienced by the consuming public when attempting to obtain desired products, services, etc. By way of example only, one type of computer-based auction for the sale of products utilizes e-mail sent over the Internet. This type of merchandising system typically involves bidders or participants in the auction sending e-mails to the auction site or controller with details of a specific bid and identity of the bidder. The bid details are posted on the web site of the auction and are available to other participants. The auction process is usually conducted over an extended time period of several days, wherein at the end of the time period the product is sold to the highest bidder. Advantages of systems of this type include the lack of complexity in Internet participation, especially where e-mail is used to communicate with the auction site. However, related disadvantages include a prolonged period of time for conducting the auction and the resulting frustration especially when the auction is frequently decided in the last few minutes before the bidding closes.

In addition to the above, at least one currently popular on-line merchandising entity is reportedly encountering problems which may affect its growth and expansion opportunities. More specifically, large corporations, retailers, suppliers, etc., desirous of merchandising large volumes of a specific product line have discovered that an on-line auction facility may not be the most effective way of distributing such merchandise to the consuming public. Attempts to sell significant quantities of the same or similar products such as cameras, laptops, desktop computers or a variety of other look-alike items resulted in the price of the item crashing due to the relatively limited number of buyers interested in the same product line as compared to the large quantity of the same merchandise offered. Therefore, distinct disadvantages of conventional on-line auction or other gaming format sites include supply and demand problems manifested in the inability to merchandise large quantities of the same or similar products.

Generally speaking, a typical auction procedure involves a seller providing information about an item of merchandise as well as the parameters with which the auction procedure must comply, including a low initial starting or bidding price. Bidding proceeds as the customers incrementally raise the bid price. At the close of bidding, the high bidder obtains the product for the amount bid, which the customer hopes will be below the normal purchase price of a given product or service. While it is recognized that the customer controls the bidding price, it is not unusual for excitement to control the customers to the extent that the bidding price reaches or exceeds the normal retail purchase price resulting in little or no savings to the winning customer. In spite of certain disadvantages, it is understandable that computer-based auctions are popular to both the seller and the buyer. Moreover, a seller can be relatively certain of reaching a large group of motivated customers and the buyer can often obtain a product at a favorable price. The competition between bidding customers is also a frequently attractive feature of the on-line auction.

Based on the above, it is believed that on-line merchandising can still be improved and many of the well recognized disadvantages thereof can be overcome. Moreover, an improved, computer based merchandising system and attendant method may be more effective by providing customers with an opportunity to obtain preselected merchandise at a reduced price, while guaranteeing that the customer will obtain the merchandise at a cost no greater than the normal purchase price of the merchandise. Accordingly, the fear of a customer losing the money invested in purchasing losing bids is eliminated.

### SUMMARY OF THE INVENTION

The present invention is directed to a system and method of merchandising a variety of products, services and other value-based merchandise by implementing a drawing, raffle, lottery, auction or other promotional game type format, primarily but not exclusively, on-line. Moreover, the various preferred embodiments of the present invention provide customers the opportunity to obtain desired merchandise at a reduced price. In addition, the customer is provided with the benefit of an added guarantee that continuing in the selected promotional format will result in the award of the merchandise at a cost which is substantially equal to the original purchase price of the preselected merchandise. Therefore, the present invention offers the convenience commonly associated with on-line merchandising and/or computer-based systems, wherein the Internet serves as the primary basis of communication and access for implementation thereof. Concurrently, the various preferred embodiments of the present invention incorporate the excitement and pricing benefits normally associated with a raffle, lottery or auction-type format. While the specifics of the merchandising system and method of the present invention will be described in greater detail hereinafter, it is emphasized that in describing some of the preferred embodiments of the present invention, the terms “raffle”, “lottery” and/or “auction” may be used interchangeably and any and/or all of these terms, as used, is not meant to be interpreted in a limiting sense. The applicable nature of such terminology is at least partially based on the present invention providing the opportunity of a plurality of customers to purchase one or more bids or entries. Further, each of the bids or entries represents an equal opportunity for the customer to be awarded preselected merchandise with which the bid or entry is associated. However, unique to the particular promotional environment incorporated within the present invention is the opportunity for each of the plurality of customers to be awarded the preselected merchandise at a potentially reduced price with the alternate guarantee of obtaining the preselected merchandise at a cost which is substantially equal to the original purchase price of the preselected merchandise.

More specifically, the present invention comprises a marketplace which may be “visited” by on-line access utilizing any computer, processor and/or peripheral facility with Internet or like network capabilities. The marketplace is controlled, at least in terms of implementing the system and method of the present invention, by a controlling entity. Generally, the controlling entity is responsible for overall operation of the on-line site, the commercial transactions conducted thereon and the proper functioning of the auction, raffle or like promotional gaming format. However, while the controlling entity is responsible for the practice of the system and method of the present invention, one preferred embodiment comprises the awarded merchandise being shipped or otherwise transported directly from an original supplier, manufacturer or distributor. The costs, responsibilities, and inconvenience associated with maintaining inventory and/or attending to the transportation of the awarded merchandise are thereby eliminated or significantly reduced.

In typical fashion, the marketplace, as well as the ancillary segments of the gaming format associated therewith, have one or more specific website locations which are easily accessible on-line. In addition, the marketplace also comprises a merchandise collection of at least some of the various products, services and other valuable merchandise categories which may be presented to the interested customers. It is emphasized that the merchandise referred to herein and as displayed in the on-line marketplace are representative only and are not limited to a specific category of products, services, gift certificates, awards, etc. To the contrary, any merchandise having commercial value and being desired by the consuming public may represent “preselected merchandise”, which is the subject of the auction, raffle or promotional game as defined in the various preferred embodiments of the present invention.

Accordingly, implementation of one or more preferred embodiments of the system and method of the present invention comprises a distribution format structured to award preselected merchandise, through the aforementioned raffle or other promotional gaming format, to one or more customers which purchase one or more bids or entries. Further, the present invention comprises the conducting of one or more auctions, raffles, promotions, etc., either independently or concurrently, wherein each raffle, auction or promotion relates to specific, preselected merchandise presented for purchase and/or distribution. As set forth above, display, review and examination of the various merchandise, prior to or during its selection, may occur by on-line access of any interested customer to the merchandise collection displayed as part of the marketplace.

In one or more preferred embodiments, once the merchandise is selected for distribution, a bid pool is established comprising a pre-determined number of bids. Each bid is available for purchase and represents an opportunity, typically an equal opportunity, for award of the preselected merchandise. The equal opportunity status of each of the bids in a given bid pool is based on the fact that the winning or selected bid is chosen randomly using computer based random selection or any other appropriate means. Therefore, the random selection of the winning bid is recognized as being more characteristic of a lottery or raffle-type gaming format rather than that of an auction. However, for purposes of descriptive clarity and as detailed above, the terms raffle, lottery, auction and promotion may be used interchangeably and are not meant to be interpreted in a limiting sense.

One feature of at least some of the preferred embodiments of the present invention is the structuring of the bids which define a given bid pool. As such, the number of bids in a given bid pool are predetermined as is the monetary value or cost of each bid. Moreover, the bid structuring parameters are at least partially based on the original purchase price or established item price of the preselected merchandise presented for bid. As such, the plurality of bids in a given bid pool represent an equal share or percentage of the purchase price, thereby further establishing that each bid represents an equal opportunity for award of the preselected merchandise.

Other features associated with the bid structuring include presenting a pre-determined number of bids in each bid pool, based on the purchase price, wherein the monetary value of each bid is estimated to be acceptable to the customer. By way of example only, preselected merchandise presented for bid may have a purchase price of $600.00. Therefore, the total number of bids defining the bid pool may be 20, wherein the monetary value of each of the 20 bids is $30.00. However, if the monetary value were raised to $100.00 for each bid, the resulting bid pool would comprise only six bids and the customer acceptance of such a high monetary value for each bid may be lessened. In the alternative, if the monetary value were lowered to $1.00 for each bid, the resulting bid pool would comprise 600 bids. While the customer acceptance of an extremely low-value bid may initially be desirable, the time required to sell 600 bids and the potentially large number of customers participating in a given auction or raffle may be impractical. Accordingly, an estimate is used as to the number and value of each bid, such that bid structuring is acceptable to the customer while allowing the auction or raffle to be conducted in a reasonably short length of time.

As indicated above, another consideration in determining the structuring of the individual bids of a common bid pool would be an estimated customer acceptable time for the entire auction or lottery to be conducted. One disadvantage in known on-line auction formats is the length of time it takes to complete the auction. Therefore, a feature of the present invention is the conducting of an auction within a relatively short period of time defined by hours rather than days. Therefore, the estimated time required to sell a pre-determined number of bids is also taken into consideration. Further by way of reference to the above-noted example, it may be easier to sell 20 bids at $30.00 each within a given time period than it would to sell 600 bids at $1.00 each. It is also taken into consideration that the controlling entity of the marketplace desires exposure of the associated website to as many economically appropriate customers as possible.

A related aspect of the present invention is the requirement that all of the bids of a given bid pool must be sold such that the bid pool is completely “exhausted” before the preselected merchandise is awarded. The exhausting of the bid pool also assures the controlling entity of the on-line marketplace that each auction or raffle generates enough money to cover the purchase price of the merchandise offered for bid. As also described in greater detail hereinafter, the exhausting of the bid pool defines a restricted number of customers which have an opportunity to be awarded the preselected merchandise of any one auction associated with the bid pool. However, any one customer may purchase one or more bids in order to increase the chances of winning based on a random selection of the winning bid.

Once a given bid pool has been exhausted, the present invention contemplates the activation of one embodiment of the distribution format, whereby the preselected merchandise associated with a given bid pool is awarded to one of the restricted number of customers holding a bid within that bid pool. However, unique to this embodiment of the distribution format is the feature of awarding the preselected merchandise and/or an equivalent thereof to any customer having purchased a number of bids having a collective monetary value to at least equal the purchase price of the preselected merchandise. More specifically, a customer may purchase one or more bids in different bid pools in an attempt to obtain or be awarded a preselected merchandise. If that customer purchases a “winning bid” the preselected merchandise is awarded to the winning bid holder at a “reduced price”. The reduced price is at least partially defined by the total monetary value of the number of bids purchased by that customer prior to be awarded the preselected merchandise.

However, if a customer fails to “win” the preselected merchandise in any of a plurality of successive auctions, that customer has not “lost” his entire investment. Instead, the customer is automatically awarded the preselected merchandise set forth above when he has purchased a number of bids having a collective monetary value at least equal to the purchase price of the preselected merchandise. Accordingly, both the opportunity to obtain merchandise at a potentially reduced price plus the guarantee that the merchandise will be obtained at a cost no greater than the original purchase price is a distinguishing benefit and operative feature of the system and method of the present invention.

As set forth above, the “reduced price” in one or more preferred embodiments is at least partially defined by the monetary value of the number of bids the customer has purchased in successive auctions until that customer obtains a winning bid. However, the system and method of the present invention further comprises preferred embodiments which include a compensation application. The compensation application is structured to provide a profit or income source to the controlling entity, more specifically described as one or more operators of the marketplace responsible for the implementation of the present invention. Accordingly, the compensation application requires that the customer holding the winning bid pay an auction fee or commission fee to the controlling entity.

Therefore, the “reduced price” of the awarded merchandise may be more completely defined as the monetary value of the total number of bids purchased by the winning customer relating to preselected merchandise in addition to the customer's payment of the auction or commission fee. The determination of the auction fee is based on a predetermined percentage of the savings enjoyed by the winning customer. As described in detail hereinafter, a winning customer's “savings” comprises the monetary difference between the original purchase price of the preselected merchandise presented for auction and the monetary value of the total bids purchased by the customer in an attempt to win that preselected merchandise.

Yet another preferred embodiment of the present invention is directed to a system and method of merchandising wherein one or more participating customers have the opportunity to obtain selected merchandise at a potentially reduced price. As with other preferred embodiments of the present invention described herein, merchandising of a plurality of products preferably, but not necessarily, occurs over a predetermined communication network, such as the Internet. Moreover, access to the website of a controlling or operating entity, responsible for the operation of the merchandising system and method provides participating customers with a marketplace and a display of a collection of merchandise which may be obtained.

One distinguishing feature of this preferred embodiment of present invention includes a layaway provision, wherein each participating customer establishes a layaway account which facilitates the purchase of selected merchandise over an unrestricted period of time. Moreover, the establishment of one or more layaway accounts by one or more participating customers has the additional advantage of participating in a “promotional drawing”. More specifically, requirements for establishing a layaway account include the contribution of a predetermined monetary payment into the layaway account. The value of the predetermined monetary payment may be established by the controlling or operating entity and may, by way of example only, be one dollar ($1.00).

Additional features of this preferred embodiment of merchandising system and method of the present invention include the establishment of a distribution format which is directly associated with the aforementioned promotional drawing. More specifically, this preferred embodiment further contemplates the establishment of an entry pool wherein each participating customer is provided an entry into the entry pool by establishing one or more layaway accounts, wherein each layaway account includes one or more contributions of the aforementioned predetermined monetary payment into the accounts. Moreover, each predetermined monetary payment, of for example one dollar ($1.00), is equal to one entry into the entry pool. The total number of entries into a given entry pool is equivalent to the total number of predetermined monetary payments made during the existence of a given entry pool. Additional restrictions on the size of the entry pool and the occurrence of the promotional drawing of a selected or winning entry from the entry pool may be based on a variety of different factors. Further by way of example, a given entry pool may be closed when the total monetary value of all the entries are at least equivalent or substantially correspond to a purchase price of merchandise being selected. Alternatively, the size of the entry pool may be the number of entries existing in the entry pool upon the termination of a given time period. As such, the controlling or operating entity of the merchandising system and method may establish that a promotional drawing will be held every 24 hours, 48 hours, 72 hours or other time period.

After the closing of the entry pool the promotional drawing occurs resulting in a random determination of a selected or winning entry. The layaway account associated with that entry is then credited a predetermined monetary amount which may be applied by a corresponding participating customer towards the purchase of the selected merchandise to which the layaway account is directed. Identifying the selected or winning entry with a corresponding one of a plurality of layaway accounts is determined by which layaway account and corresponding participating customer contributed the predetermined monetary payment into an account which resulted in the selected or winning entry being a part of the entry pool for a given promotional drawing.

Further the credited monetary amount to a winning layaway account may vary in that it is preferably based on a percentage of the remaining balance between the paid portion existing in the winning layaway account and the purchase price of the selected merchandise. As set forth in greater detail hereinafter, the “paid portion” of any layaway account is the total monetary value or amount of all of the predetermined monetary payments made into that account by a corresponding participating customer. Therefore it should be apparent that the actual dollar value of the credited monetary amount into a winning layaway account may vary based upon the size of the remaining balance of the winning layaway account.

By way of example, if a participating customer associated with a winning layaway account has selected merchandise with a purchase price of $750 and the participating customer has already contributed a “paid portion” of $250, the remaining balance in that layaway account is $500. As the winning layaway account, the credited predetermined monetary amount to that winning layaway account would be a predetermined percentage, such as seventy percent (70%), of the remaining balance or $350. Therefore in order to purchase the selected merchandise the corresponding customer would have to contribute an additional $150, plus taxes, handling and shipping fees, to have the merchandise delivered.

Other features associated with this preferred embodiment of the system and method of the present invention include the layaway provision being devoid of any specific number of predetermined monetary payments being made, as well as the absence of any specific payment schedule being required to maintain the layaway account, once it has been established. Also, additional advantages associated with the aforementioned layaway provision are the establishment of one or a plurality of layaway accounts by each participating customer. Also, subject to a predetermined transfer fee, a participating customer is given the opportunity to transfer certain monetary amounts from one layaway account into one or more other layaway accounts with which the customer is associated.

Also, product upgrades are available at the option of the participating customer and/or controlling or operating entity as will be explained in greater detail here and after.

Accordingly, the preferred embodiments of the merchandising system and method of the present invention are implemented by a promotional format through on-line access to a controlling entity's website. As structured and practiced the promotional format offers a participating customer the potential of obtaining preselected merchandise at a significantly reduced price. Moreover, many of the disadvantages and problems associated with conventional merchandising systems and methods, as well as problems associated with existing or known computer-based merchandising techniques are thereby overcome.

These and other objects, features and advantages of the present invention will become more clear when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a schematic representation in block diagram form of the implementation and operative features of the merchandising system and method of the present invention.

FIG. 2 is a composite view of a merchandise collection including at least some of the available preselected merchandise represented as part of an on-line accessible marketplace and presented in the form of a window or displayed page of a website associated with the system and method of the present invention.

FIG. 3 comprises an on-line accessible window or displayed page of a website representing a gaming format and other operative details of the system and method of the present invention.

FIG. 4 comprises an on-line accessible window or displayed page of a website representing additional features of the gaming format and other operative features of the system and method of the present invention.

FIG. 5 comprises an on-line accessible window or displayed page of a website representing additional features of the gaming format and other operative features of the system and method of the present invention.

FIG. 6 is an on-line accessible window or displayed page disclosing in part a preferred embodiment relating to a compensation application and other operative features of the system and method of the present invention.

FIG. 7 is an on-line accessible window or displayed page of a preferred embodiment relating to a “Buy-It-Now” option of the system and method of the present invention.

FIGS. 8A, 8B and 8C are each on-line accessible windows or displayed pages of another preferred embodiment relating to a “Funds Transfer” option of the system and method of the present invention.

FIGS. 9A, 9B and 9C are each on-line, accessible windows or displayed pages of another preferred embodiment relating to a “Product Upgrade” option of the system and method of the present invention.

FIG. 10 is a schematic representation in block diagram form of another preferred embodiment relating to an electronic gift card option of the present invention.

FIG. 11 is a schematic representation in block diagram form of yet another preferred embodiment of present invention.

FIG. 12 is a schematic representation in block diagram form of a most preferred embodiment of the system and method of the present invention.

Like reference numerals refer to like parts throughout the several views of the drawings.

### DETAILED DESCRIPTION OF THE PREFERRED EMBODIMENT

As represented in the accompanying Figures, the present invention is directed to a system and method of on-line merchandising of a variety of different products, services, gift cards and any other type of merchandise having commercial value and appeal to the general consuming public. Practice and implementation of the present invention is conducted on-line using the Internet or other communication network by accessing a “marketplace” website. Practice of one or more preferred embodiments of the present invention more specifically entails the implementation of a distribution format, such as a raffle, lottery and/or promotional drawing system. Moreover, the specific terminology used to describe the distribution format of the present invention is not meant to be interpreted in a limiting sense. Accordingly, the terms raffle, lottery, auction and/or drawing may be used interchangeably to describe the functional and operational features of the various preferred embodiments of the present invention, as set forth in detail hereinafter.

Further, the operative components and functional characteristics of the present invention, which are distinguishable from known or conventional on-line or computer-based merchandising techniques, provide a plurality of customers the opportunity to obtain preselected merchandise at a potentially reduced price. In addition, the system and method of the present invention provides the additional, highly attractive feature of guaranteeing an award of the preselected merchandise to a continuously participating customer at a cost substantially equal to the original or pre-determined purchase price (listed item price) of the preselected merchandise.

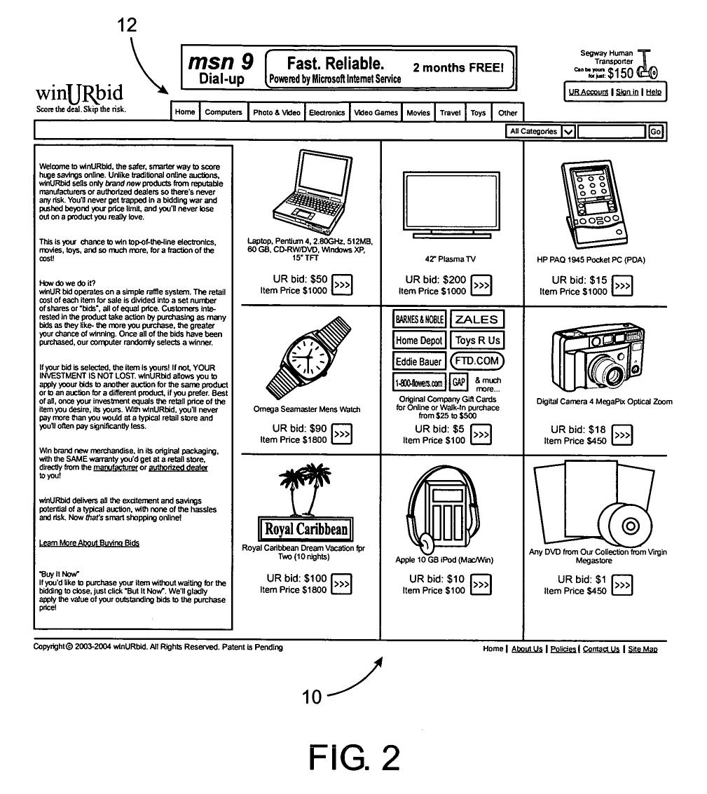

Accordingly, a plurality of customers establish on-line access to the marketplace available at one or more web sites maintained and operated by a controlling entity. The marketplace includes a plurality of easily accessible windows or displayed pages each demonstrating in a clear and informative manner the various components of the present invention, as well as procedures and operative features relating to its practice. With reference to FIG. 2, the marketplace comprises a merchandise collection generally indicated as 10 and including a composite display of the various products, services, gift certificates and/or other valuable merchandise available to be awarded or obtained through the a raffle, lottery, auction, or like gaming format. The merchandise displayed in FIG. 2 is representative only of the various types of merchandise which are available to a large number of customers participating in the system and method of the present invention. The merchandise collection, as part of the marketplace of a preferred embodiment of the present invention, may also include a plurality of merchandise categories generally indicated as 12. By way of example only, the merchandise categories 12 may include computers, photo and video equipment, electronics, video games, movies, travel, toys as well as a variety of other such categories. The availability of the category display 12 in combination with the composite representation of the merchandise of FIG. 2 facilitates the access by an on-line customer to specific merchandise associated with the respective categories which may be of primary interest to the customer.

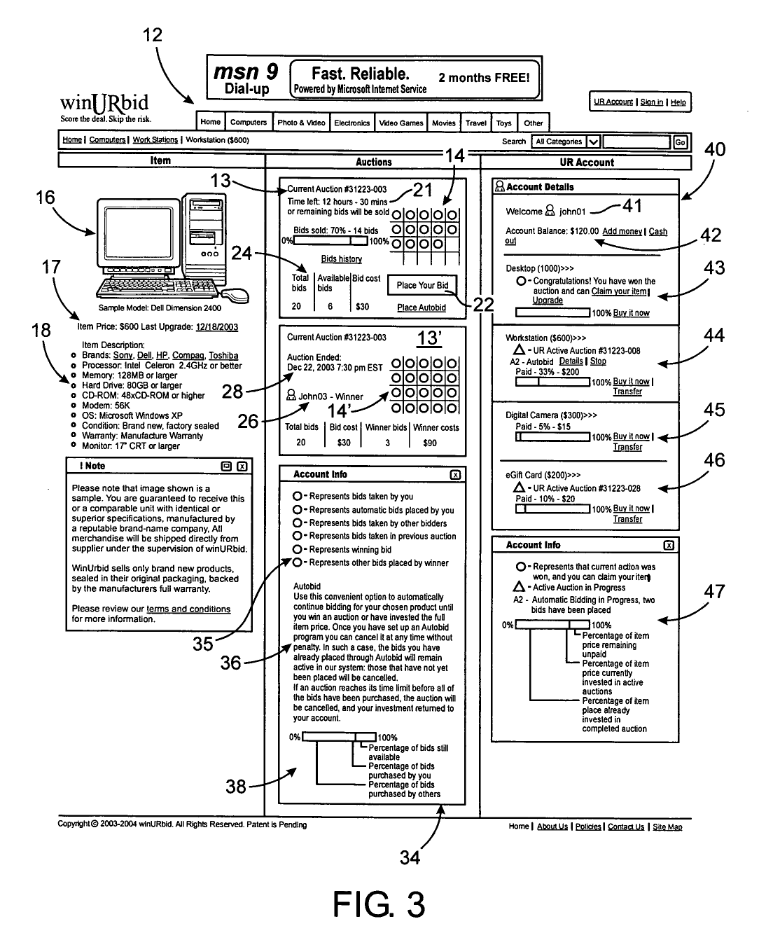

As emphasized above, the raffle, auction or like gaming format which defines certain operative features of the present invention includes the establishment of a “bid pool” 14. Each bid pool 14 includes a pre-determined number of bids, each of which are available for on-line purchase. As demonstrated in FIG. 3, a currently operating auction 13 comprises an active bid pool 14 as well as a schematic representation of a previous bid pool 14′, wherein the auction 13′ associated therewith has already been completed. Each of the plurality of bids in a given bid pool 14 and 14′ represents an equal opportunity to be awarded preselected merchandise 16. As further demonstrated in FIG. 3, the preselected merchandise 16 represents a product, service, etc., which is the subject of the current auction 13 as well as the previous auction 13′. As indicated above, preselected merchandise associated with any given auction 13 and its associated bid pool 14 may of course vary and may be determined by customer demand and/or be under the supervision of the controlling entity of the marketplace.

Additional features demonstrated in the displayed window/page of FIG. 3 include a display of the purchase or item price 17 as well as informative data 18 relating to the preselected merchandise 16, as well as informative parameters of the current auction 13 and results of the previous auction 13′. Further with regard to the bid pools 14, 14′, each comprises a pre-determined number of bids having an established monetary value. The monetary value of each bid in a given bid pool is at least partially determined by the purchase price 17 of the preselected merchandise 16, displayed as the “item price” in FIG. 3, and a variety of other factors. As such, each of the bids represents a “share” or percentage of the purchase price 17 of the preselected merchandise 16.

The structuring of the bids in terms of the number of the bids available for purchase in any given bid pool 14 is additionally determined by an estimated value. As used herein, the “estimated value” is a determination of a bid value which is believed to be acceptable to a customer in terms of attracting an optimum or acceptable number of customers to participate in each of the raffles or auctions. By way of example only and again with primary reference to FIG. 3, it may be a realistic estimate to establish 20 bids in a given bid pool 14 based on the purchase price 17 of the preselected merchandise 16 being $600.00. As such the value or customer cost of each bid, being equal, would be $30.00. The $30.00 value of each bid would an estimate of a purchase price that would be acceptable to a large number of customers.

In addition, the bid structuring of the present invention comprises the establishment of a predetermined number of bids which would best facilitate a bid pool 14 being exhausted or sold out within a relatively short and/or optimum period of time. Therefore, the determination that 20 bids define the number of bids in a given bid pool would represent an estimate, believed to be customer acceptable, of the number of bids which could be sold in an acceptable time period. This would overcome the recognized disadvantages of known on-line auction systems, which typically take several days to complete.

Moreover, an additional operative feature of the present invention is the necessity of exhausting the bid pool, by selling all of the plurality of bids defining a specific bid pool 14, before the auction 13 can take place. This will assure that each of the auctions 13, 13′, etc., generate sufficient monetary funds to at least cover the purchase or unit price 17 of the preselected merchandise 16. At the same time, each bid represents an equal opportunity for the bid holding customers to be awarded the preselected merchandise 16.

With further reference to FIG. 3, additional information available to on-line customers includes the time and/or time remaining 21 of the current auction 13; the provision of a window or screen-shot button 22 for the purchase of one or more of the plurality of bids; the updated status 24 of the current auction 13 in terms of total, pre-determined number of bids in the bid pool 14; the bids remaining for purchase or “available bids”; and the cost of each bid. Similarly, information relating to the previous auction 13′ may include the display of at least a partial identity of the winning customer 26; the date and time of auction termination 28; and the “reduced price” at which the winning customer 26 obtained the preselected merchandise 16, which was the subject of the auction or raffle 13′. Also, additional information relating to the previous auction 13′ may be provided and include that there were 20 total bids contained in the bid pool 14′; the winning customer 26 purchased three bids and this three bid purchase resulted in a $90.00 investment by the wining customer 26, based on the fact that each bid was purchased for an individual monetary value of $30.00.

Other components and operative features of the various preferred embodiments of the present invention are demonstrated throughout the accompanying Figures. More specifically, an “Auction Info” screen segment, generally indicated as 34, is continuously or selectively available and includes information relating to current, past and future auctions and possibly a variety of other topics. More specifically, such informative data comprises, but is not limited to, various icon-type indicators, which may be displayed as a composite and generally indicated as 35. Such icon indicators provide additional auction information in terms of indicating the bids purchased by a given customer; bids purchased by an auto-bid format 36 (to be described in greater detail hereinafter); bids placed in one or more previous auctions; an indicator for the one or more winning bids in a plurality of auctions and further indicators representing the non-winning or losing bids. Also, the Auction Info segment 34 may provide an active diagram 38 of information of a given customer, as well as the participation by competing customers as a percentage of the bids still available for purchase; the percentage of bids purchased by a single customer; and the percentage of bids purchased by other customers; all relating to a common bid pool 14 and/or 14′.

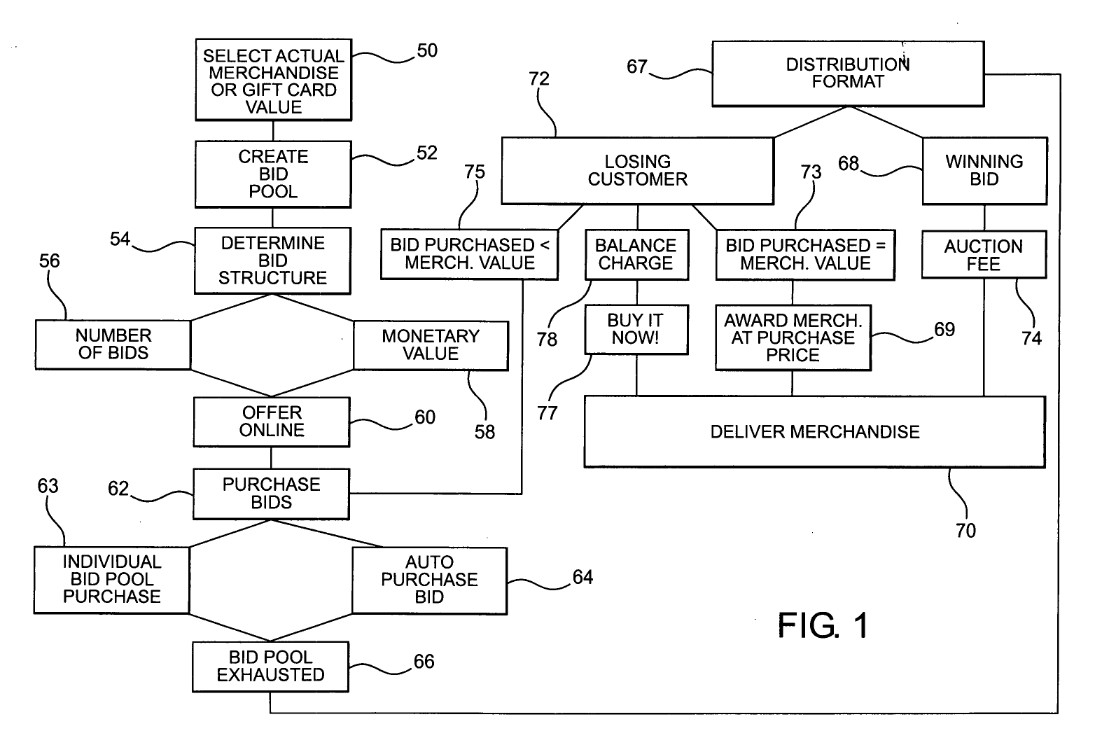

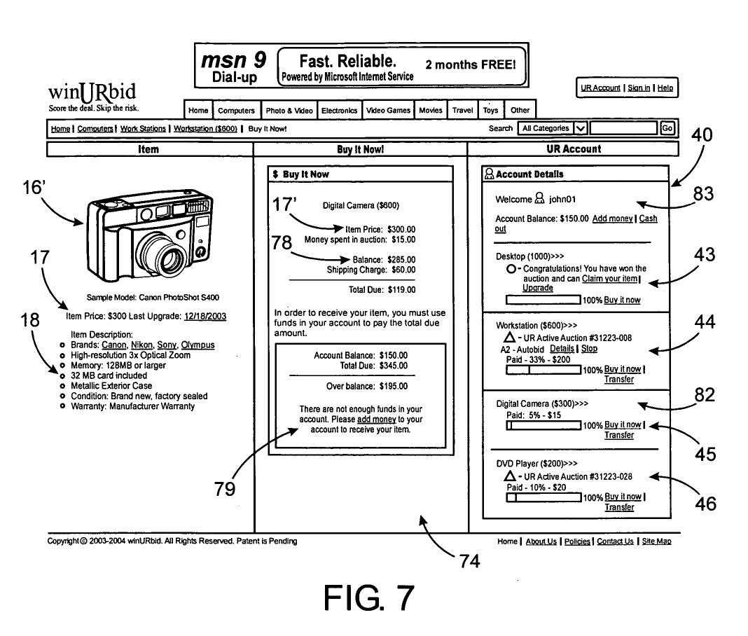

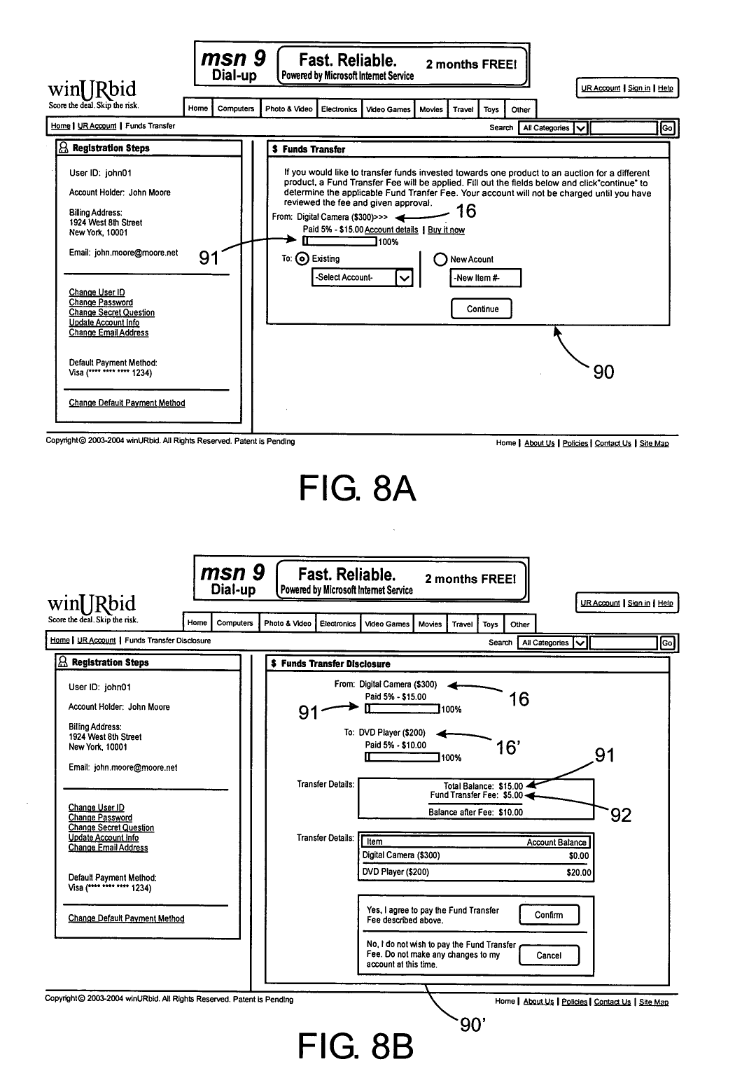

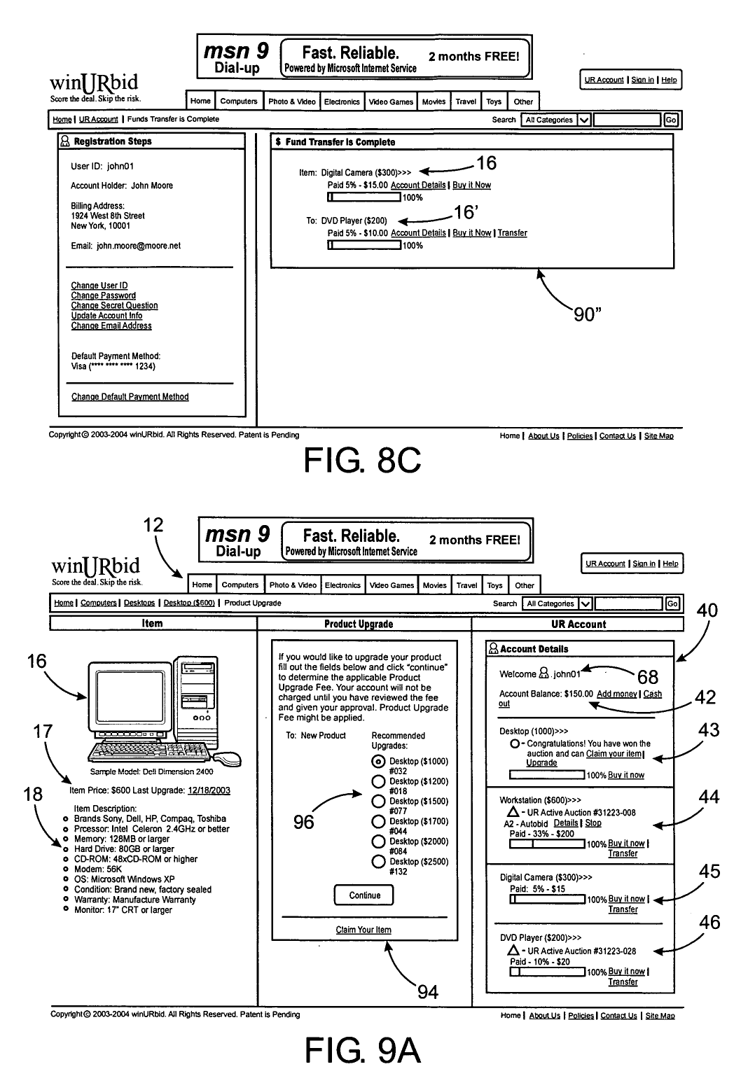

In order to keep each of the on-line customers fully informed as to the status of their individual financial account(s), as well as provide an on-going reference to their participation or position in current, past and future auctions, an “Account Details” screen segment 40 is provided on appropriate displayed widow/pages. With specific reference to FIG. 3, the Account Details segment 40 may include the identity of the individual customer 41, an account balance 42, plus the selective ability to add money to one's account or to cash out or have the funds in the account balance 42 returned. In addition, information relating to the successful winning of an auction 43 may be provided as well as the specific details relating to the won auction. Further, the status of the individual customer 41 relating to one or more future auctions as at 44, 45, 46, etc., is also informatively displayed. Moreover, each of the future auction window segments 44-46 may provide the customer 41 with a plurality of selections relating to the continued participation in a given auction; the ability to choose a “Buy-It-Now” option 77, as discussed with reference to FIGS. 1 and 7; the ability to transfer the value of the purchased bids to another preselected merchandise, as discussed in FIGS. 8A through 8C, and a current value of the one or more bids purchased by the customer 41 in each of one or more future auctions 44-46. As an added component of the Account Detail segment 40, additional related information termed “Account Info”, generally indicated as 47, may also be provided. Such an “Account Info” segment 47 may comprise an active graph similar to that demonstrated in the window segment 34 relating to “Auction Info” but more directly associated with the account details of the specific customer 41 as described with reference to the Account Details segment 40, set forth above.

The operative features and components of the merchandising system and method of the present invention will be further clarified hereinafter with primary reference to FIG. 1 as well as the various features of the preferred embodiments as represented in FIGS. 3 through 9. More specifically, operation of the system and method of the present invention, including the responsible implementation of the various embodiments by a controlling entity (not shown for purposes of clarity), may best begin with the selection of merchandise as at 50. The selected merchandise is represented in the various Figures as the preselected merchandise 16, 16′, 16″, etc. and may vary when conducting different auctions each including a different bid pool 14. As such, the bid pool 14 is created, as at 52, by determining the bid structuring 54. The bid structuring 54, under the responsibility of the controlling entity, relates to the determination of the number of bids in the bid pool 14, as at 56, as well as the monetary value 58 of each of the plurality of bids of a given bid pool 14.

As previously indicated, the number of bids and the monetary value thereof are based on plurality of factors including an established purchase price or item price 17 of the preselected merchandise 16. The number of bids 56, in any given bid pool, will be based on a customer-acceptable estimated value 58 as well as an estimated time period for conducting the raffle or auction before awarding the preselected merchandise 16. Further, the plurality of bids each represent a “share” of the purchase price of the preselected merchandise 16, and therefore each of the plurality of bids of a given bid pool 14 will have the same monetary value 58.

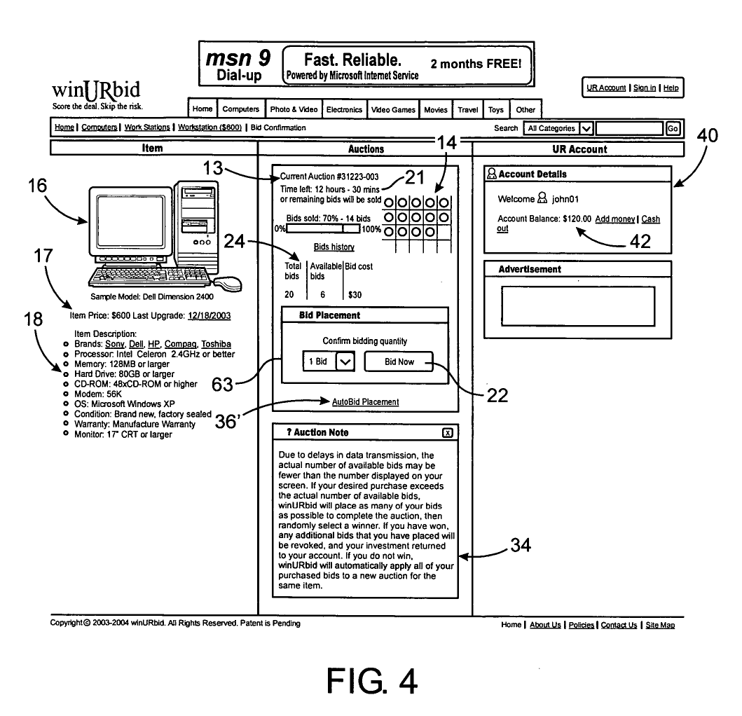

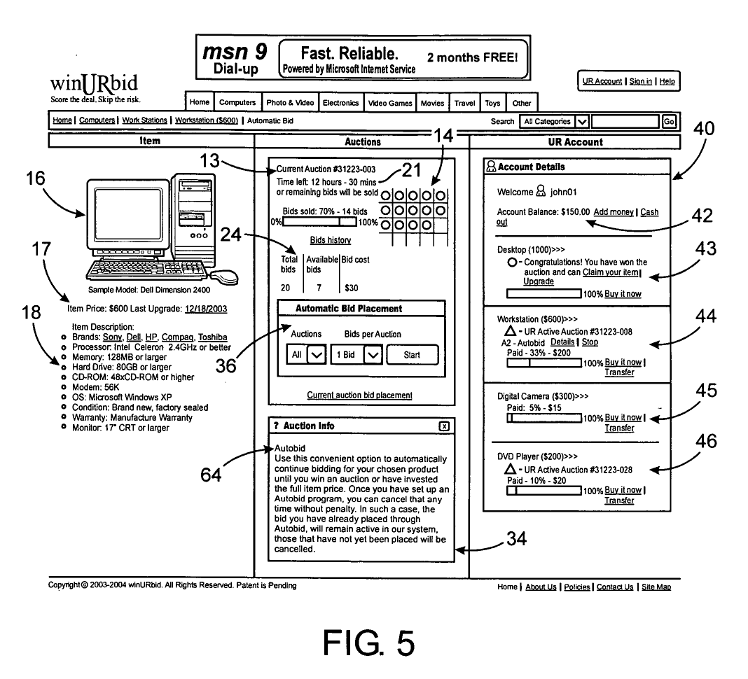

Once the bid pool 14 has been created, through proper structuring of the plurality of bids 54, they are offered for on-line purchase, as at 60. With additional reference to FIGS. 4 and 5, the purchase 62 of the bids can be accomplished by any customer visiting the website of the marketplace and preferably, but not necessarily, establishing a financial account. As set forth above, the status of a customer's individual financial account will be currently updated, depending upon the customer's activity and indicated in the Account Details segment 40 which is displayed on appropriate windows represented throughout the various Figures. The establishing of a financial account facilitates the purchase of one or more bids either individually or “manually”, as at 63 (see FIG. 4), or through an “Auto-Bid Format” 64 (see FIG. 5). More specifically, an individual bid may be placed by activating the “Bid Now” screen displayed button 22, wherein current information is instantaneously displayed to the customer at least in terms of bid quantity.

Alternatively, at least one preferred embodiment of the present invention comprises the auto-bid format 64 schematically represented in FIG. 1 and informatively described in the Auction Info segment 34 of FIG. 5. As such, the auto-bid format 64 provides for a customer establishing the above noted financial account and authorizing the automatic, continued purchase of at least one bid in a plurality and/or successive auctions for the same or equivalent preselected merchandise 16. As indicated, the auto bid format 64 can be cancelled at any time, but will normally continue until customer purchases a winning bid. However, it is recognized that the customer may never purchase a wining bid. If this occurs, the customer will still not lose his investment, as described in greater detail hereinafter. The purchase of bids 62 by any of a plurality of customers, through on-line access, can be accomplished by a customer individually, as at 63, or automatically, as at 64, once the customer has determined in which, if any, of the auctions he/she wishes to participate. Moreover, a customer may purchase one or more bids from a given bid pool 14 and if not awarded the preselected merchandise 16 may choose not to participate in the next auction or any other successive auction.

Regardless of the procedure used to purchase 62 the one or more bids in a given bid pool 14, the auction will begin only when the bid pool has been exhausted, as at 66. As indicated above, the exhaustion of the bid pool is defined as the selling of all of the predetermined number of bids in any given bid pool 14. This assures that the total value of any exhausted bid pool is at least equal to the purchase price 17 of the preselected merchandise 16. The controlling entity of the marketplace will thereby be provided sufficient income dollars to cover the purchase price 17 of the preselected merchandise 16. Once the bid pool 14 has been exhausted, as at 66, the award of the preselected merchandise 16 will commence through activation of the distribution format 67.

Therefore, one distinguishing feature of the system and method of the present invention is the structuring of the distribution format 67 in a manner which provides for the awarding of the preselected merchandise 16 at a “reduced price” to a customer holding a winning bid, as at 68. In addition, the preselected merchandise 16 is also guaranteed to be awarded to any “losing” customer 69 which has already purchased a sufficient number of bids, wherein the total monetary value of all the bids purchased is at least equal to the purchase price or unit price 17, as at 53. Therefore, the structuring of the distribution format 67 provides an opportunity to obtain merchandise at a significantly reduced price, by obtaining the winning bid through the purchase of only a small number of bids, as at 68, and the guarantee that the merchandise will be awarded at a cost no greater than the purchase price 17, as at 69.

As further indicated in FIG. 1, the situation will frequently occur where many or even most of the losing customers 72 participating in a given bid pool 14, will have purchased one or more bids which have a total monetary value less than the purchase price 17, as at 75. In such situations, each of the losing customers 72 having purchased an insufficient number of bids 75, may or may not continue participation in successive bid pools 14. However, in order to guarantee a customer the award of the merchandise 16, at a price no greater than its purchase price 17, at least one preferred embodiment of the present invention necessitates continued participation of that customer in successive bid pools.

Such continued participation comprises the purchase of bids from bid pools 14 of other, successive auctions 13 for the same preselected merchandise 16, until the monetary value of the total number of bids purchased by a customer is at least and/or substantially equal to the purchase price 17 of that preselected merchandise 16. Once an equivalent monetary value has been reached, the continuously losing customer is awarded the merchandise 16 at the full purchase price, which is substantially equal to the total monetary value of all the bids that customer has purchased at successive raffles or auctions. As with the purchase of bids from any bid pool 14, the losing customer may participate in the auto-purchase application 64 or may otherwise purchase bids individually as at 63.

With further reference to FIG. 1, a losing customer 72 has yet another alternative comprising a “Buy-It-Now” option 77, which is represented in greater detail in FIG. 7. More specifically, situations may arise where a losing customer 72 is desirous of obtaining the preselected merchandise 16, 16′, etc., immediately without participating in successive auctions and/or bid pools. In this situation, the losing customer 72 relinquishes the possibility of purchasing a winning bid 68. But, for any of a variety of reasons, the customer may wish to take possession of the preselected merchandise 16, 16′ as soon as possible.

Accordingly, the losing customer 72, in accord with the “Buy-It-Now” option 77, will have the balance, represented as 78 in both FIGS. 1 and 7, charged to his/her account, which is maintained with the controlling entity. The balance 78 in the example presented in FIG. 7 equals $285 which is the difference between the money spent on bids in one or more auctions ($15) and the purchase or item price 17′ of the preselected merchandise 16′ ($300). The charging of the balance 78 for the preselected merchandise 16′ is, as set forth above, deducted or debited from the account maintained by the specific losing customer 72 as represented in FIG. 7 as 79. The various Account Details 40 are also concurrently displayed to inform any given customer his/her immediate financial condition in any of a plurality of auctions, such as but not limited to the specific auction as at 82 relating to the preselected merchandise 16′. In providing a customer with an accurate account of his/her activities and financial situation including, but not limited to, his/her account balance 83, all of the activities concerning past, current and future auctions are also represented in FIG. 7.

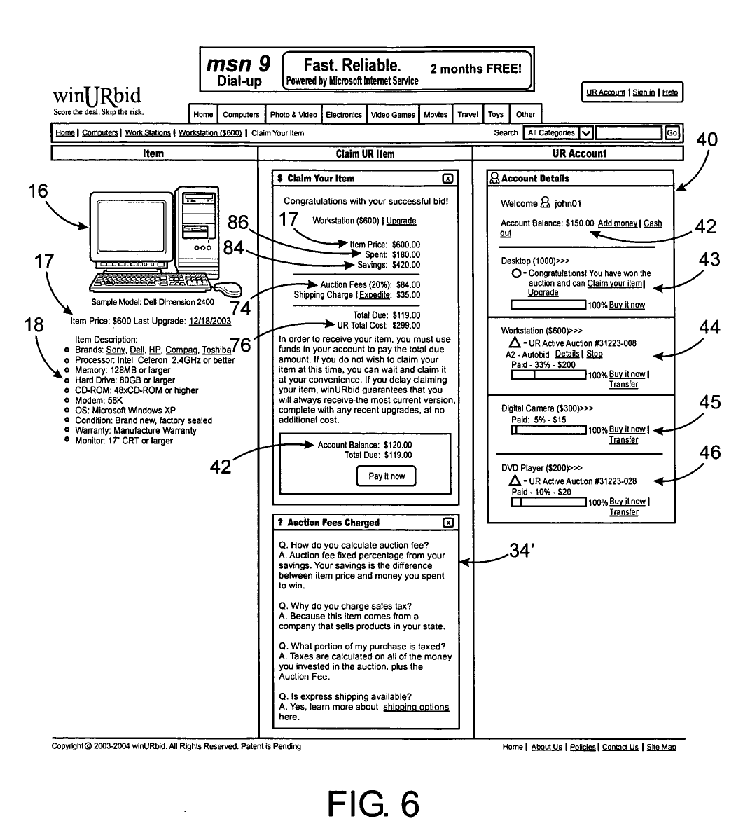

As also schematically represented in FIGS. 1 and 6, other features of preferred embodiments of the present invention include the provision of a compensation application which may represent a primary or at least significant profit source for the controlling entity of the marketplace website. The compensation application is structured to include the payment of an auction fee or commission fee 74 to the controlling entity by each customer holding the winning bid 68. As such, the aforementioned “reduced fee”, generally indicated as 76, at which any customer has the opportunity to obtain the preselected merchandise 16, 16′, etc, is defined as the monetary value 86 of the total number of bids which the customer needed to purchase to obtain a winning bid. Also, the reduced price 76 includes the additional factor of the winning customer 68 paying the commission or auction fee 74.

Again, with primary reference to FIG. 6, the auction fee 74 comprises a predetermined percentage of the “savings” 84 enjoyed by the winning customer 68. In turn, the savings 84 is defined as the difference in the purchase price 17 of the preselected merchandise 16 and the monetary value 86 of the total number of bids purchased by the winning customer until the winning bid was obtained and the preselected merchandise 16 was awarded. As such, it should be apparent that the auction fee 74 is inversely proportional to the monetary value 86 of the total number of bids purchased for the preselected merchandise by the winning customer. In other words, the more the customer spends on purchasing bids 86, the less that customer will realize in savings 84. Therefore, the smaller the savings 84 the smaller the commission fee 74 paid by the winning customer 68. Also, it should be apparent that when a customer is awarded the preselected merchandise at full price, as at 69, due to the purchase of a sufficient number of non-winning bids, that customer's “savings” is zero since the merchandise will be obtained by the losing customer at a cost substantially equal to the original purchase price or item price 17.

Yet additional features which may be attractive to both the controlling entity of the marketplace and/or the plurality of customers, include the existence and transfer of original warranties on the products as supplied by the original supplier or manufacturer. Further, in a preferred embodiment the preselected merchandise 16, 16′, etc, whether awarded at the full purchase price, as at 68; obtained by the “Buy It Now” option 77; or awarded to the winning bid holder, as at 69, is preferably shipped or otherwise delivered, as at 70, directly from the manufacturer or supplier. Therefore, if the customer has an issue relating to delivery and/or condition of the product, it is dealt with directly by the supplier or manufacturer. Also, no costs or inconvenience associated with maintaining an inventory of merchandise need be suffered by the controlling entity.

Other features demonstrated in at least some of the preferred embodiments of the present invention are intended to assure customer satisfaction. More specifically, situations may arise where the preselected merchandise 16, 16′, etc., intended to be presented for bid, may not be available. In such circumstances, the merchandise will be upgraded and changed to substantially equivalent merchandise. If such an event occurs, the bids purchased from a given bid pool will be automatically applied to the upgraded or other equivalent merchandise.

Yet another preferred embodiment of the present invention is schematically represented in FIGS. 8A-8C and comprises an option which allows any customer to transfer the value of his purchased bids on a specific preselected merchandise 16 to an equivalent value of bids for a different preselected merchandise 16′. This “Funds Transfer” option is generally indicated and described by sequential screen segments 90, 90′ and 90′ respectively presented in FIGS. 8A-8C. With reference to the example presented in these Figures, a customer has purchased a number of bids attempting to obtain preselected merchandise 16, such as a digital camera. Thereafter the same customer wishes to obtain other preselected merchandise, such as a DVD player 16′. When taking advantage of this option of the present invention, the value of the previously purchased bids, as at 91, can be transferred to or credited against the purchase of the other merchandise 16′ such as the DVD player. In such situations, a funds' transfer fee, as at 92, may be charged to the customer. As represented, the result would be a zero balance applied to the digital camera 16 and an increased monetary value transferred or applied towards the DVD player 16′ as demonstrated in FIG. 8C.

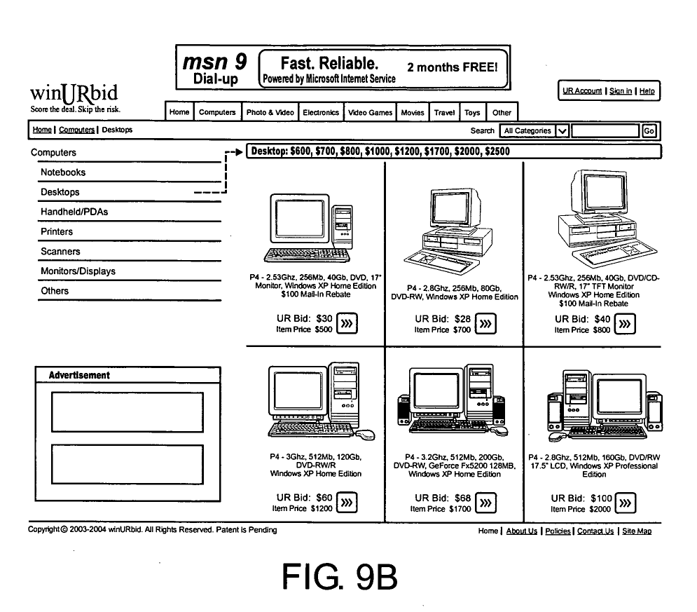

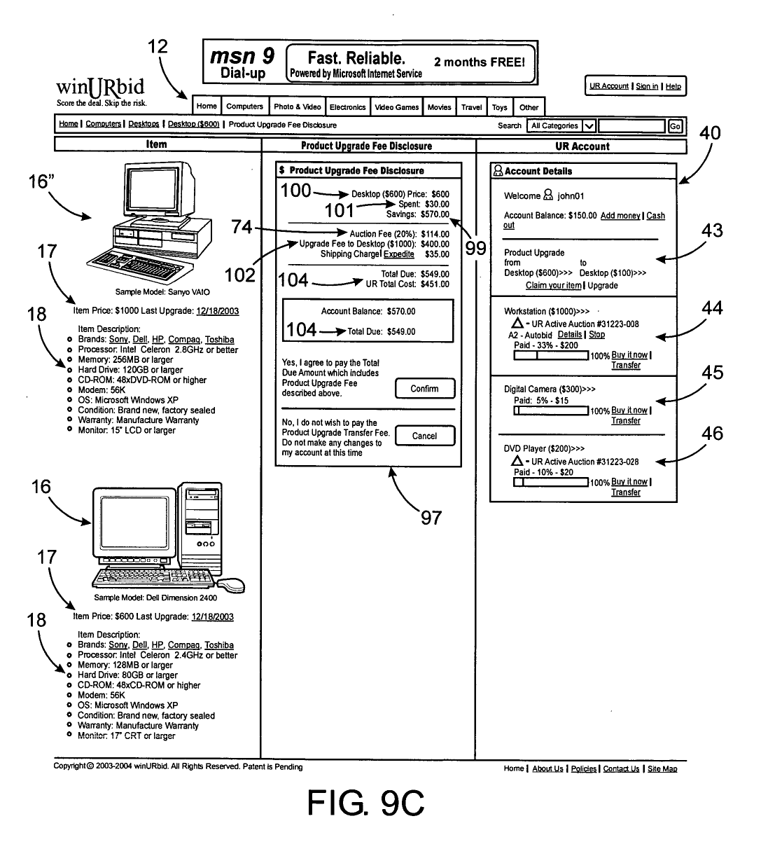

The versatility and customer appeal of the on-line merchandising system and method of the present invention is further demonstrated in yet another preferred embodiment, represented and described in FIGS. 9A-9C. More specifically, each customer specifically including, but not limited to, the winning customer 68, has the option of a “product upgrade” as generally represented in the window segment 94. As indicated above, the marketplace and associated auction website presents numerous categories of merchandise for auction. Within each category, such as an electronics category 12′, a plurality of products may be represented. Those products may include a variety of different desktop computers ranging in style, performance capabilities, etc., resulting in different prices. The window segment 94 therefore demonstrates a plurality of the different styles of desktop computer products and is generally represented as 96. Accordingly, a winning customer 68 of a preselected merchandise 16, comprising one type of desktop computer (# 032), will be presented with the product upgrade option 94. As part of this product upgrade option 94, the plurality of different styles, types, etc., of computers 96 may be accessed and visually displayed as represented in FIG. 9B. Again, assuming that the customer 68 was a winning bid holder and decided to choose an upgrade to a different desktop computer, as at 16″ in FIG. 9C, he/she would be allowed to do so and be subsequently presented with the financial data or criteria for obtaining the upgraded merchandise 16″. At the same time, the winning customer 68 would be able to enjoy the benefit of holding a winning bid which enabled the customer 68 to obtain or be awarded the original merchandise 16 at a greatly reduced price. As set forth above, the reduced price would be at least partially determined by the savings 99, defined by the difference between the purchase price 100 and the total monetary value of the bids purchased in an attempt to win the original preselected merchandise 16, as at 101. As also set forth above, an auction fee or commission fee 74 would be added to the reduced price, based on the amount of savings 99. The upgrade fee 102 would be the difference between the purchase price of the original merchandise 16 and the purchase price of the upgraded merchandise 16″. Additional administrative charges such as shipping charges may be added to determine the total amount due 104 from the winning customer 68 which need be paid to obtain the upgraded merchandise 16″. It should be further noted that any customer, whether being designated as a winning customer or losing customer, can participate in the product upgrade option 94, 97 as described. In the case of a losing customer, the total monetary value of all the bids purchased by the losing customer would be applied against the purchase or unit price 100 of the upgraded merchandise 16″ even though the losing customer purchased bids on the original preselected merchandise 16.

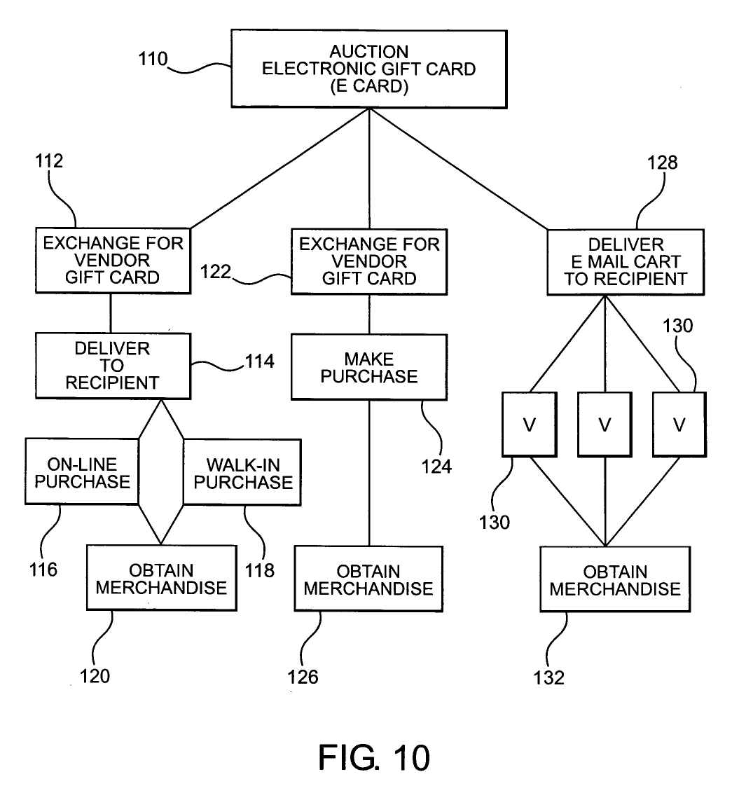

As set forth above, one of the many features of the present invention comprises the ability to auction or raffle a plurality of different categories and types of merchandise, wherein the merchandise is not limited to a product or service. Accordingly, with primary reference to FIG. 10, one preferred embodiment of the present invention comprises the preselected merchandise being defined by a gift card or certificate more appropriately termed an “Electronic Gift Card” indicated as 110. For purposes of clarity, the term “Electronic Gift Card” is not meant to be interpreted in a limiting sense. As such, a variety of different terms, logos, trade names, etc., may be used herein and in a practical commercial application to identify the Electronic Gift Card or its equivalent. Such additional terms may include “eMoney”, “eCard” and/or a plurality of other terms generally representative of the electronic or computerized transactional nature of this merchandise. In addition, the Electronic Gift Card is structured and functionally designed to be utilized in a plurality of different types of commercial transactions.

Again with reference to FIG. 10, one option for commercially transacting the Electronic Gift Card comprises the winning customer or bid holder exchanging the Electronic Gift Card for a gift certificate or gift card of one of a plurality of specific vendors 112. Thereafter, the specific vendor gift card 112 is delivered to an intended recipient, as at 114, for which the winning customer intended a gift. The recipient thereafter has the option of choosing a variety of different merchandise of the specific vendor. Moreover, the merchandise can be selected and/or purchased on line as at 116 or by visiting one or more of the vendor's physical locations in order to accomplish a walk-in purchase, as at 118. Regardless of whether the purchase of the merchandise is an on-line transaction 116 or a walk-in transaction 118, the merchandise is then obtained by the recipient as at 120. Obtaining the merchandise by the recipient may comprise delivery by any conventional or other appropriate means, especially when the merchandise is purchased on-line 116. Alternatively, when purchasing merchandise by a walk-in transaction 118, the recipient may take possession of the merchandise in the conventional fashion at the vendor's physical establishment or have it delivered by conventional or appropriate means.

Yet another option associated with the commercial transaction of the electronic gift card comprises the winning customer or bid holder exchanging the electronic gift card for a gift certificate or gift card of a specific vendor, as at 122. The customer, then being in possession of the specific vendor's gift certificate, will select and purchase merchandise as at 124 from the vendor. The selection and purchase of the merchandise can preferably be conducted on line in order to eliminate the inconvenience of visiting a physical outlet or location of the specific vendor. However, it is emphasized that the electronic gift card is structured and operative to allow the winning customer to visit any of one or more of the vendor's physical facilities or outlets. Obtaining of the merchandise, as at 126, represents such merchandise being delivered to the recipient either directly by the winning customer or by other conventional or appropriate means.

The commercial versatility of the electronic gift card is further demonstrated in yet another option, wherein the electronic gift card itself is delivered to the recipient. Such delivery can be arranged by the winning customer and can be conducted on line. Alternatively, the winning customer can obtain some type of hard copy evidence representing of the electronic gift card and send or otherwise deliver the hard copy representation to the recipient as at 128.

In practicing this particular option, the electronic gift card or the hard-copy representation will not necessarily be limited to a specific vendor as in the previous options 112 and 122. To the contrary, the electronic gift card can be a universal or “No Name” card or certificate. As such, the recipient, once in the possession of the electronic gift card and/or its hard-copy representation, can visit any of a plurality of vendors 130 which have been integrated into the merchandising system and method of the present invention to the extent of the vendor accepting the electronic gift card and exchanging it for desired merchandise. As with the previously described options relating to the commercial transaction of the electronic gift card 110, a prearrangement will be made with a plurality of vendors wherein the number and popularity of the vendors will be such as to provide the recipient and/or the winning customer with a wide choice of merchandise from which to select and purchase. As with the previous options, the merchandise is obtained by the recipient by direct physical possession and/or conventional or appropriate delivery means. Further, once the recipient receives the “No Name” electronic gift card, an appropriate commercial transaction with any of the plurality of vendors 130 can be conducted either on line or by means of a walk-in transaction, as described above.

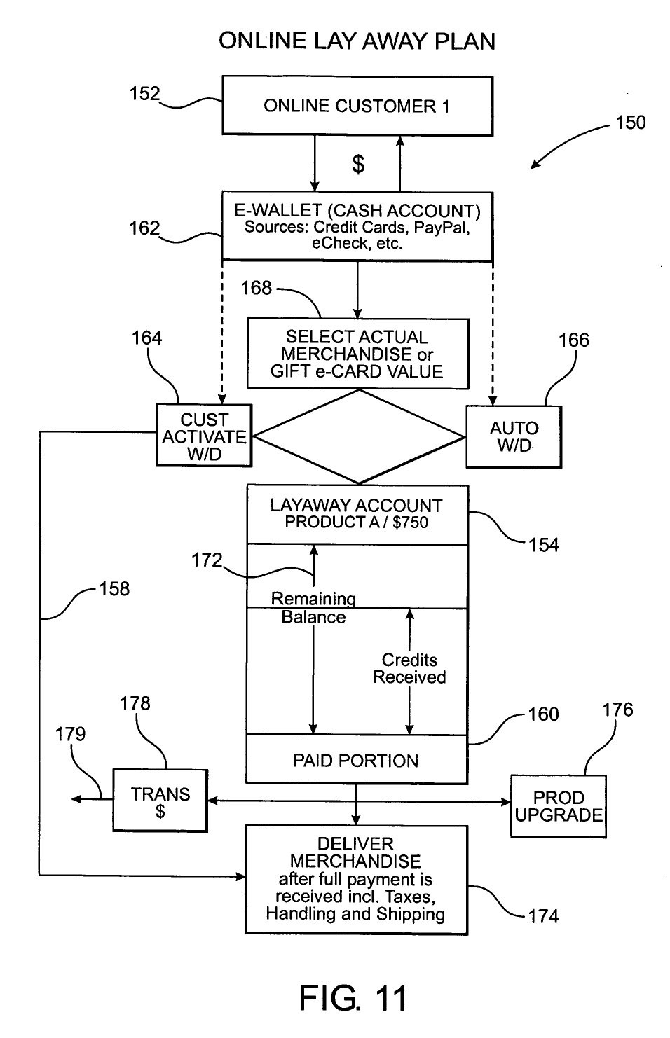

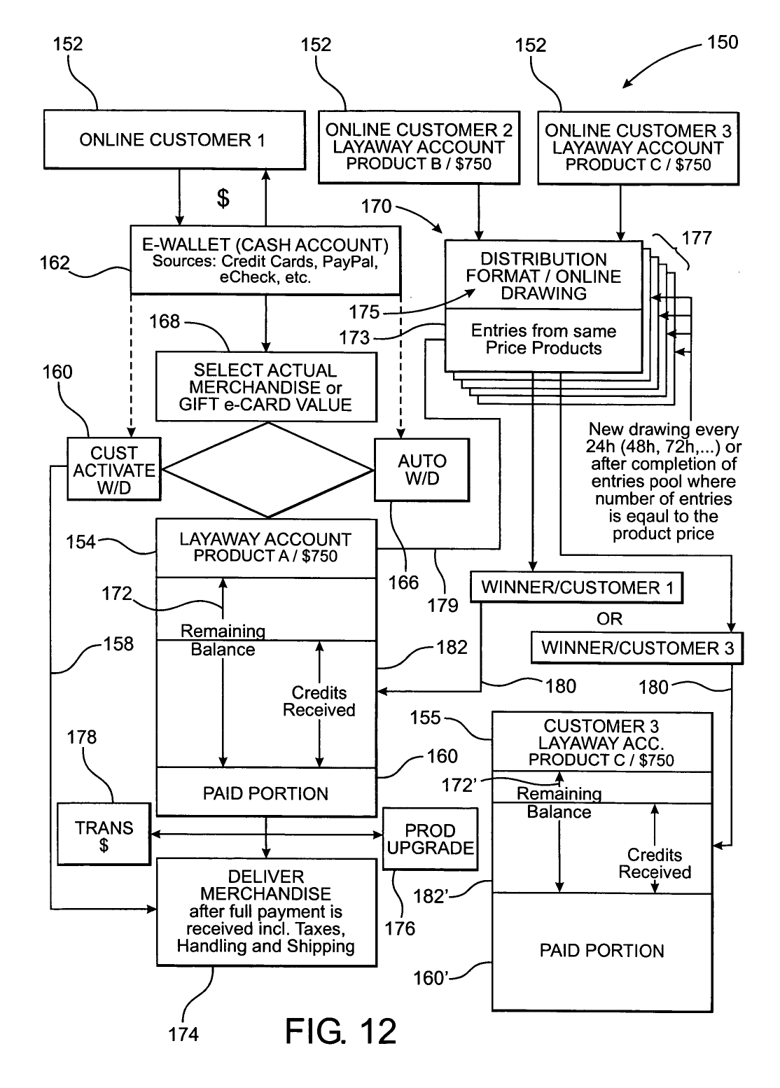

As schematically represented in FIGS. 11 and 12, a most preferred embodiment of the merchandising system and method of the present invention is generally indicated as 150. While this most preferred embodiment of the present invention is primarily intended to be participated in on an “on-line” basis, it is not limited to such an environment. More specifically, at least one but more practically a plurality of participating customers 152 access the website of a controlling or operating entity, wherein the website and the offered collection of merchandise is generally represented in FIG. 2. As such, each of the participating customers 152 preferably “enters” the marketplace or website by means of a predetermined communication network, such as the Internet.

With primary reference to FIG. 11, one feature of this most preferred embodiment is the incorporation of a layaway plan or provision. The layaway provision comprises each of the plurality of participating, on-line customers 152 establishing one or more layaway accounts 154, 155, 156, etc. As such, the layaway provision facilitates the ability of any one or more of the participating customers 152 to purchase selected merchandise over a period of time or on a delayed basis by not requiring the purchase price of the selected merchandise to be paid at one time. However, it is to be emphasized that an alternative feature which may be incorporated in the merchandising system and method 150 is the option of allowing any on-line customer 152 to purchase the selected merchandise immediately and/or directly, as at 158, without participating in the layaway provision or the establishment of a layaway account 154, as will be explained in greater detail hereinafter.

The establishment of one or more layaway accounts 154 by each of the participating customers 152 is accomplished by the contribution of at least one predetermined monetary payment into the corresponding layaway account 154. Also, each of the predetermined monetary payments contributed to each of the layaway accounts 154 at least partially defines what may be referred to as a “paid portion” 160 of that layaway account 154, 155, etc. Further, payment of the one or more predetermined monetary payments is best facilitated, in accordance with the embodiments of FIGS. 11 and 12, by the establishment of a customer account 162 by each of the participating customers 152 which participate in the layaway plan or provision. The customer account 162 is established by deposits or contributions made thereto in the form of cash, checks, electronic transfers, credit cards, PayPal™ contributions, etc. Accordingly, the customer account 162 may also be thereby referred to as an electronic wallet or “e-wallet” in that money can be added thereto or subtracted there from electronically by on-line access. The establishment of the e-wallet or customer account 162 thereby allows quick and efficient transfer of one or more predetermined monetary payments into each of the one or more layaway accounts 154 through appropriate accessing and participation in the website (FIG. 2) of the controlling or operating entity. Also noted, at least one embodiment of the present invention includes the provision of a maintenance requirement to maintain of “keep open” at least one of the layaway accounts. Such a maintenance requirement comprises an initial and continued balance in the layaway account in order to establish and maintain it in good standing.

For further convenience, each of the withdrawals from the e-wallet or customer account 162 can be customer activated as at 164 or the customer 152 may establish automatic withdrawals as at 166. The automatic withdrawal capabilities of the customer account 162 for deposit into the layaway accounts 154, 155, etc. may comprise a predetermined number of predetermined monetary payments into any one or more of the layaway accounts 154 associated with a given participating customer 152, at any predetermined time interval. The referred to time interval can vary thereby enabling the participating customer 152 to choose one or more predetermined monetary payments being made into a given layaway account every week, month, etc. Alternatively the on-line customer 152 may choose to automatically withdraw and transfer one or more predetermined monetary payments 166 into a corresponding layaway account 154, each time a promotional drawing 170 takes place, as will be described in greater detail with reference to the schematic representation of FIG. 12.

Again with primary reference to FIG. 11, the participating customer 152 will establish one or more layaway accounts 154 and create a customer account 162 substantially concurrently with the selection of merchandise, as at 168, for purchase. As such, the established layaway account 154 is directed to specific merchandise, such as “Product A” which, by way of example only, may have a preestablished purchase price of $750. When the layaway account 154 has been established, by the creation of a paid portion 160 being deposited therein, the corresponding participating customer 152 will have a remaining balance 172. This remaining balance 172 will be the difference between the paid portion 160, comprising the one or more predetermined monetary payments made by the corresponding participating customer 152 into the account, and the purchase price of $750. As set forth above, the participating customers 152 cannot obtain delivery and ownership of the selected merchandise until the remaining balance 172 has been paid. Also, the delivery of the merchandise to the customer, as at 174, is dependent on payment of the remaining balance 172 in a given layaway account 154, as well as full payment of taxes, handling and shipping fees, etc. However, the payment of the taxes and other additional fees will not be a part of the purchase price per se, and must be paid independently of payments made into a corresponding layaway account. The payment of all necessary taxes, shipping and/or handling fees is also required before delivery to a customer that decides not to participate in the layaway provision or plan and pays the entire purchase price of $750 immediately, as at 158, as described above.

Additional features and advantages of participating in the layaway provision or plan schematically represented in FIG. 11 is the ability of the controlling entity to substitute an upgraded product 176 for the initial merchandise selected. Such a product upgrade may be necessary based in part on the fact that there is no required time period for a participating customer 152 to pay the full amount of the purchase price. Therefore, the initial merchandise selected by the participating customer 152 may no longer be available. Further, since technology, services and advancement in product development occur on a continuing basis, the controlling or operating entity may reserve the right to upgrade the product associated with a given layaway account at any time. With further reference to the selection of merchandise 168 by a participating customer 152, such merchandise may be any product, service or other commodity of value including a “gift e-card” as explained in detail above with reference to the embodiment of FIG. 10.

Yet additional advantages associated with the on-line layaway provision or plan represented in FIG. 11 is the ability to transfer different monetary amounts 178 from one or more layaway accounts 154 to any one or more of an additional number of layaway accounts associated with the same participating customer 152, as at 179. Also, the number of layaway accounts established by each participating customer may vary and is unlimited in that a customer may want to be involved in the purchase of many products. However, the transfer option 178 will subject the participating customer to a predetermined transfer fee of a predetermined percentage such as, by way of example only, 15% of the monetary amount transferred. It is also to be understood that a product upgrade 176, instigated by the operating entity and the transfer capabilities 178 instigated by the participating customer 152 may occur at any time prior to, but not after, the customer 152 paying the taxes and additional fees relating to shipping and handling.

With primary reference to FIG. 12 the expanded, schematic representation presented therein is provided as a more specific explanation of the distribution format 170 in relation to a plurality of participating customers 152. For purposes of clarity, each of the participating customers 152 will be designated as customer 1, customer 2, customer 3, etc. It is further emphasized that in order to take advantage of the opportunity to obtain the selected merchandise at a reduced price, each of the participating customers 152 must participate in the layaway provision or plan as schematically represented in FIG. 11 and described in detail above. Moreover, each customer 1, customer 2, customer 3, etc. establishes an e-wallet or customer account 162 prior to or concurrently with the opening of corresponding layaway account 154, 155. Further, each of the customer accounts 162 has the capability of automatic withdrawal 166 or a manual or customer activated withdrawal 164 when contributing to a given layaway account 154, 155, etc. Also, the contribution to each layaway account 154, 155 will be equal to one or more predetermined monetary payments used to establish the paid portion 160 of each of the respective layaway accounts.

As also emphasized above, each of the predetermined monetary payments submitted into each of the layaway accounts 154, 155, etc. represents one entry into what may be referred to as an entry pool 173. Moreover the establishment or creation of the entry pool 173 may be considered an operative portion of the distribution format which includes an on-line promotional drawing as at 175. Therefore each time any of the customers 1, 2, 3, etc. contribute one or more predetermined monetary payments into their respective layaway accounts 154, 155, etc., a number of entries, equal to the number of predetermined monetary payments are added to the entry pool 173 and directly associated with the corresponding participating customer 1, 2, 3, etc. As such, the number of entries of each customer 1, 2, 3, etc. is equivalent to the number of predetermined monetary payments made by that customer into their respective layaway accounts 154, 155, etc. As set forth above, the monetary amount of the predetermined monetary payment for each customer 1, 2, 3, etc. is equal and may be established by the operating or controlling entity to be a substantially small amount such as, but not limited to, one dollar ($1.00).

As represented in FIG. 12, it should be noted that each of the established layaway accounts 154, 155, etc. may be directed to different specific products or merchandise such as Product A, Product B, Product C, etc. However in order to assure that the distribution format, including the promotional drawing 175 is equitable to all of the participating customers 152, the purchase price of the various merchandise selected as at Product A, Product B, Product C, etc. should be the same. By way of further emphasis and clarity, Products A through C each have a purchase price of $750.

The distribution format 170 includes the conducting of a plurality of promotional drawings, collectively indicated as at 177. Each individual drawing 175 is preferably associated with its own entry pool 173 and will be conducted based on the accumulation of a sufficient number of entries in the respective entry pool or the expiration of a predetermined time period. More specifically, since each entry represents a payment into a participating customer's layaway account, a drawing may be conducted when an entry pool has a total monetary value which substantially corresponds to the purchase price of the selected merchandise for that drawing. Again the monetary value of the total number of entries into an entry pool 173 is equal to the value of the predetermined monetary payments made into the plurality of layaway accounts for a given drawing 175.

Also, a given entry pool 173 may be closed and the promotional drawing 175 may occur when a given time period or interval has expired, regardless of the total monetary value of the entry pool. Such time intervals may include, but not be limited to, 24 hours, 48 hours, 72 hours, or any other appropriate time interval. While the predetermined time period or interval may be based on a belief by the controlling or operating entity that a sufficient number of entries will exist in the respective entry pool 173 to correspond to the purchase price of the selected merchandise, ultimately the total monetary value of an entry pool is not the controlling factor.

By way of example, if the purchase price of the merchandise being sold such as product A, B, C, etc. is $750, there will be 750 “slots” in the entry pool 173 which may be selected when the random drawing 175 takes place. If after a given time period or interval has expired, the number of entries equivalent to the number of monetary payments made into associated layaway accounts is less than the total number of “slots” existing in the corresponding entry pool 173, there will be a number of “empty slots”. Further by way of example, there will be 750 “slots” in an existing entry pool 173 for a product having a purchase price of $750.00. Assuming that each monetary payment, equaling $1.00, defines an entry into the entry pool, there may be only 250 “paid entries” and 500 “empty slots” at the end of given period when the entry pool 173 is to be closed and the drawing 175 is to begin. Accordingly, during the conducting of the drawing 175, if an empty slot is randomly chosen rather than an entry which represents or is defined by a monetary payment into a layaway account, there will be no awarding of a monetary credit, as at 180, 182, to a layaway account since an “empty slot” was randomly selected. On the other hand, if a paid entry was randomly selected, the corresponding layaway account 154, 155, etc. would be awarded a monetary credit 180, 182, as will be explained in greater detail here and after. Therefore, the conducting of a promotional drawing 175 may or may not determine a selected or winning entry in every case.

As indicated, a winning or selected entry from the entry pool 173 will be representative of an entry from a specific layaway account 154, 155, etc. as well as the participation customer 152 including customer 1, 2, 3, etc. associated therewith. The identifying of a selected or winning entry chosen during the promotional drawing from the entry pool 173 can be easily identified with an appropriate layaway account 154, 155, etc. due to the fact that each entry is the result of one predetermined monetary payment being made into one of the layaway accounts 154, 155, as schematically represented as 179.

Therefore, the distribution format 170 provides for the determination, on a preferably random basis, of the winning or selected entry and the identifying of that selected entry with one of the layaway accounts 154, 155, etc. Thereafter the distribution format is further structured to credit a predetermined monetary amount 180 into a corresponding “winning” layaway account 154 or 155, wherein the winning layaway account is directly associated with the selected or winning entry, as set forth above. Further, the predetermined monetary amount awarded as a result of randomly determining the selected or winning entry, will be credited to the winning layaway account. This credited amount will result in a “credit received” contribution, 182 or 182′, to the winning layaway account 154 or 155.

The amount credited into the winning layaway account 154 or 155 may differ based on defining the credited, predetermined monetary amount as a percentage of the remaining balance existing in the winning layaway accounts 154 or 155. By way of example if customer 1 is associated with the winning layaway account 154, the credited predetermined monetary amount representing the credits received 182 will be a predetermined percentage of the remaining balance 172. In contrast, if customer 3 is associated with the winning layaway account 155 the credits received 182′ will equal the credited predetermined monetary amount and be a predetermined percentage of the remaining balance 172′. However in either instance the remaining balance 172 and/or 172′ differs based on the monetary value of the paid portion 160 and 160′ of the different layaway accounts 154 and 155.

Further by way of example it is noted that the purchase price of Product A and Product C, associated with the different layaway accounts 154 and 155 is $750. However the paid portion 160 of the layaway account 154 is schematically indicated as being significantly less than the paid portion 160′ of the layaway account 155. Therefore, while the credits received 182 and 182′ may differ in monetary value, each of the credited predetermined monetary amounts resulting in being the winning layaway account 154 or 155 is based on an equal percentage of the remaining balance, such as, but not limited to, seventy percent (70%) of the remaining balance 172 and 172′.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A system of on-line merchandising at a potentially-reduced price, said system comprising:
a market place accessible on a predetermined communication network and comprising a controlling entity and a merchandise collection,
a layaway provision structured to facilitate delayed purchase of selected merchandise by participating customers,
said layaway provision comprising a predetermined monetary payment by participating customers towards a purchase price of the selected merchandise into a layaway account,
an entry pool comprising a plurality of entries, each entry defined by one of said predetermined monetary payments by at least one participating customer, and
a distribution format structured to determine a selected entry from said entry pool and a credit of a predetermined monetary amount towards the purchase price of selected merchandise of a participating customer corresponding to said selected entry.

2. A system as recited in claim 1 wherein said distribution format comprises a drawing application structured to determine said selected entry.

3. A system as recited in claim 2 wherein said distribution format is structured to randomly determine said selected entry.

4. A system as recited in claim 2 wherein said distribution format is structured to conduct a plurality of drawings at predetermined time intervals.

5. A system as recited in claim 2 wherein said distribution format is structured to conduct said drawings when a monetary amount of said entries in said entry pool substantially correspond to said purchase price of the selected merchandise associated with a drawing.

6. A system as recited in claim 1 wherein said layaway provision comprises a plurality of said layaway accounts each associated with at least one of said participating customers and comprising a paid portion and a remaining balance.

7. A system as recited in claim 6 wherein said paid portion comprises a total of said predetermined monetary payments paid into a corresponding layaway account.

8. A system as recited in claim 7 wherein said remaining balance comprises a monetary difference between said paid portion and said purchase price of selected merchandise associated with a corresponding layaway account.

9. A system as recited in claim 8 wherein said predetermined monetary amount comprises a predetermined percentage of said remaining balance.

10. A system as recited in claim 8 wherein each of the participating customers are associated with one or more of said layaway accounts.

11. A system as recited in claim 8 wherein at least some of said layaway accounts include maintenance requirements comprising an initial and continued balance of said paid portion of at least one predetermined monetary payment.

12. A system as recited in claim 8 wherein in at least some of said layaway accounts include transfer capabilities comprising a transfer of at least a portion of a monetary balance of one layaway account into at least one other layaway account.

13. A system as recited in claim 12 wherein said transfer capabilities further include a transfer fee payable by a participating customer associated with said transfer.

14. A system as recited in claim 13 wherein said transfer fee comprises a percentage of the monetary amount transferred.

15. A system as recited in claim 1 further comprising a customer account established by each of said participating customers, each customer account comprising at least one source of said predetermined monetary payments into corresponding ones of said layaway accounts.

16. A system as recited in claim 15 wherein said customer account includes automatic withdrawal capabilities comprising automatic transfer of a predetermined number of predetermined monetary payments into at least one layaway account associated with said participating customers at predetermined intervals.

17. A system as recited in claim 16 wherein said customer account further includes manual withdrawal capabilities comprising customer activated transfers of one or more predetermined monetary payments into at least one layaway account associated with said participating customer.

18. A system as recited in claim 15 wherein in at least some of said layaway accounts include transfer capabilities comprising a transfer of at least a portion of a monetary balance of one layaway account into at least one other layaway account.

19. A system of on-line merchandising at a potentially reduced price, the system comprising:
a marketplace accessible on-line and comprising a controlling entity and a merchandise collection,
a layaway provision comprising a plurality of layaway accounts each associated with at least one of a plurality of participating customers,
each of said plurality of layaway accounts comprising a predetermined monetary payment made by a corresponding participating customer and applied against a purchase price of selected merchandise,
an entry pool comprising a plurality of entries, each entry defined by one of said predetermined monetary payments, and
a distribution format structured to select an entry from said entry pool and crediting a predetermined monetary amount into a corresponding one of said layaway accounts associated with said selected entry.

20. A system as recited in claim 19 wherein at least some of said layaway accounts comprise a paid portion and a remaining balance; said paid portion comprising a total monetary value of said predetermined monetary payments in a corresponding layaway account.

21. A system as recited in claim 20 wherein said remaining balance comprises a monetary difference between said paid portion and said purchase price.

22. A system as recited in claim 21 wherein said predetermined monetary amount comprises a predetermined percentage of said remaining balance.

23. A system as recited in claim 20 wherein at least some of said layaway accounts include transfer capabilities comprising a transfer of at least a portion of a monetary balance of one layaway account into at least one other layaway account.

24. A system as recited in claim 23 wherein said monetary balance comprises said paid portion.

25. A system as recited in claim 24 wherein said monetary balance further comprises said predetermined monetary amount.

26. A system as recited in claim 19 wherein each of said participating customers are associated with one or more of said layaway accounts.

27. A system as recited in claim 19 further comprising a customer account established by each of said participating customers and comprising at least one source of said predetermined monetary payments into at least one of said layaway accounts.

28. A system as recited in claim 27 wherein said customer account includes automatic withdrawal capabilities comprising automatic transfer of a predetermined number of predetermined monetary payments into at least one layaway account associated with the participating customer at predetermined intervals.

29. A system as recited in claim 27 wherein said customer account further includes manual withdrawal capabilities comprising customer activating transfers of at least one of said predetermined monetary payments into at least one layaway account associated with said participating customer.

30. A method of merchandising at a potentially reduced price, said method comprising:
displaying a merchandise collection,
having each of a plurality of participating customers establish at least one layaway account for the purchase of selected merchandise,
establishing each layaway account by each participating customer making a predetermined monetary payment into the at least one layaway account,
creating an entry pool having a plurality of entries each associated with at least one participating customer,
defining each entry as one predetermined monetary payment made by a participating customer into a layaway account,
establishing a distribution format by eventually determining at least one selected entry from the entry pool, and
further defining the distribution format as crediting a predetermined monetary amount into the layaway plan from which the selected entry originated.

31. A method as recited in claim 30 further comprising structuring at least some of the layaway accounts as including a paid portion and a remaining balance.

32. A method as recited in claim 31 comprising defining the paid portion as a total monetary value of the predetermined monetary payments contributed to the corresponding layaway account.

33. A method as recited in claim 32 further defining the remaining balance as a monetary difference between the paid portion of the layaway account and the purchase price of the selected merchandise associated with the layaway account.

34. A method as recited in claim 33 comprising defining the predetermined monetary amount credited to the layaway account as a predetermined percentage of the unpaid balance of that layaway account.

35. A method as recited in claim 30 comprising having each participating customer establish a customer account from which at least some of the predetermined monetary payments are paid into selected ones of the layaway accounts.

36. A method as recited in claim 35 comprising automatically withdrawing at least one predetermined monetary payment from the customer account into at least one of the layaway account at predetermined intervals.

37. A method as recited in claim 30 further comprising transferring at least a portion of a monetary balance of at least a first layaway account into at least a second layaway account by a participating customer.
